(19) United States
(12) Patent Application Publication
(10) Pub. No.: US 2021/0026015 A1
(43) Pub. Date: Jan. 28, 2021

(54) APPARATUS FOR ASCERTAINING A DISTANCE TO AN OBJECT

(71) Applicant: Carl Zeiss AG, Oberkochen (DE)

(72) Inventor: Vladimir DAVYDENKO, Bad Herrenalb (DE)

(21) Appl. No.: 17/010,726

(22) Filed: Sep. 2, 2020

Related U.S. Application Data
(63) Continuation of application No. PCT/EP2019/055494, filed on Mar. 6, 2019.

(30) Foreign Application Priority Data
Mar. 6, 2018 (DE) 10 2018 203 316.1

(51) Int. Cl. G01S 17/34; G01S 7/481; G01S 17/42

(52) U.S. Cl. CPC G01S 17/34; G01S 17/42; G01S 7/4817

(57) ABSTRACT

An apparatus for ascertaining a distance to an object has a light source that emits an optical signal having a time-varying frequency. An evaluation device ascertains a distance to the object based on a measurement signal that originated from the optical signal and was reflected at the object and, and on a reference signal that was not reflected at the object. A deflection device changes an angle, at which the measurement signal is steered to the object, during a period of the optical signal in which the frequency of the optical signal has a monotonic time dependence.

### CROSS-REFERENCE TO RELATED APPLICATIONS

This application is a continuation application of International application No. PCT/EP2019/055494, filed Mar. 6, 2019, which claims priority to German patent application No. 10 2018 203 316.1 filed Mar. 6, 2018. Each of these applications is incorporated by reference herein in its entirety.

### BACKGROUND OF THE INVENTION

### Field of the Invention

The invention relates to an apparatus for ascertainment of a distance to an object. The apparatus can be used to ascertain distances to both moving and stationary objects and, in particular, to ascertain the topography or form of a spatially extended three-dimensional object.

### Prior Art

For the purposes of measuring the distance to objects by optical means, a measurement principle also referred to as LIDAR is known, amongst others, in which an optical signal whose frequency changes in time is emitted to the relevant object and evaluated after back-reflection has taken place at the object.

FIG. 4a shows, merely in a schematic illustration, a basic set up, known per se, in which a signal 411 with a time-varying frequency (also referred to as “chirp”), emitted by a light source 410, is split into two partial signals, this split being implemented, for example, by way of a partly transmissive mirror, which is not illustrated here. The two partial signals are coupled by way of a signal coupler 450 and superposed at a detector 460, with the first partial signal, as a reference signal 422, reaching the signal coupler 450 and the detector 460 without a reflection at the object denoted by “440”. By contrast, the second partial signal incident at the signal coupler 450 or at the detector 460, as a measurement signal 421, propagates to the object 440 via an optical circulator 420 and a scanner 430, is reflected back by said object and consequently arrives at the signal coupler 450 and the detector 460 with a time delay in comparison with the reference signal 422 and a correspondingly altered frequency.

An evaluation device (not illustrated) is used to evaluate the detector signal supplied by the detector 460 relative to the measuring apparatus or the light source 410, with the difference frequency 431 between the measurement signal 421 and reference signal 422, said difference frequency being captured at a certain time and illustrated in the diagram in FIG. 4b, being characteristic for the distance to the object 440 from the measuring apparatus or the light source 410. According to FIG. 4b, the time-dependent frequency curve of the signal 411 emitted by the light source 410 can also be designed so that there are two periods in which the time derivatives of the frequency generated by the light source 410 are opposite to one another; this is to obtain additional information in respect of the relative speed between the object 440 and the measuring apparatus or the light source 410.

By determining characteristic parameters of the time curve of the difference frequency, in particular the time curve of the instantaneous frequency, it is possible to ascertain the relative acceleration between the object 440 and the measuring apparatus or the light source 410, in addition to the relative speed. In this context, reference is made to the patent application DE 10 2018 201 735.2, filed on Feb. 5, 2018.

In practice, there is a need to realize a distance measurement that is as accurate as possible with a high scan rate (i.e., a high speed of scanning individual regions of the object) even in the case of objects (possibly even moving objects) that are situated at relatively large distances, which could be vehicles in traffic, for example. With regard to the prior art, reference is made purely by way of example to US 2016/0299228 A1.

### SUMMARY OF THE INVENTION

Against the aforementioned background, it is an object of the present invention to provide an apparatus for scanning ascertainment of a distance to an object, which facilitates a distance measurement at a high scan rate and with a limitation of the equipment outlay required to this end, even for an object situated at a comparatively large distance (e.g., of several 100 m).

This object is achieved by way of the features of independent patent claim 1.

An apparatus according to the invention for scanning ascertainment of a distance to an object comprises:
a light source for emitting an optical signal with a time-varying frequency;
an evaluation device for ascertaining a distance to the object on the basis of a measurement signal that arose from the optical signal and was reflected at the object and on the basis of a reference signal that was not reflected at the object; and
a deflection device for changing the angle at which the measurement signal is steered to the object, during a respective period with a monotonic time dependence of the frequency of the optical signal.

In an apparatus for scanning ascertainment of a distance to an object, proceeding from the principle described on the basis of FIGS. 4a-4b, the invention is based, in particular, on the concept of the measurement signal, respectively steered to the object, being deflected to the object at different angles already within a period with a monotonic time dependence of the frequency, with the consequence that different frequencies or frequency ranges are encoded differently (specifically by setting different angles) in accordance with the time dependence of the frequency of the measurement signal. Expressed differently, according to the invention, one and the same period with a monotonic time dependence of the frequency in the measurement signal is used for different regions or pixels to be scanned on the object for the purposes of measuring the distance.

In turn, this renders it possible to distinguish the relevant different angles, set by the deflection device according to the invention, on a detector arrangement during the subsequent separation of the different frequencies or frequency ranges in space by way of a suitable spectral element, as will still be explained in more detail below.

Here, an assignment between the frequencies and frequency ranges, angles and locations is achieved overall on the detector arrangement on account of, firstly, the assignment of different frequencies or frequency ranges of the measurement signal to different angles, implemented by way of the deflection device, and on account of, secondly, the assignment of different frequencies or frequency ranges to different locations in space, generated by the aforementioned spectral element. In turn, this assignment can be used to determine the corresponding object distances by way of the calculation of the difference frequency with respect to the frequency of the reference signal, which is not reflected at the object. For moving objects, this assignment can be used to determine the corresponding object distances by way of determining characteristic parameters of the time curve of the difference frequency, in particular of the time curve of the instantaneous frequency.

As a result, this allows a significant increase to be obtained in the scan rate when ascertaining the distance of even faraway objects (e.g., objects situated at a distance of several hundred meters). Here, the scan rate is understood to mean the number of scanned pixels per second (corresponding to the reciprocal of the time required to scan a pixel).

According to one embodiment, a scan rate obtainable by the apparatus when capturing object distances of up to 100 m is increased by a factor of at least two, in particular by a factor of at least three, further particularly by a factor of at least four, in relation to an analogous apparatus without the change of the angle implemented during a period with a monotonic time dependence of the frequency of the optical signal.

Expressed differently, according to one embodiment, a scan rate obtainable by the apparatus according to the invention when capturing object distances of up to 100 m is increased by a factor of at least two, in particular by a factor of at least three, further particularly by a factor of at least four, in relation to a second scan rate, this second scan rate being obtainable by an alternative apparatus for scanning ascertainment of a distance to an object, wherein this alternative apparatus comprises a light source for emitting an optical signal with a time-varying frequency and an evaluation device for ascertaining a distance to the object on the basis of a measurement signal that arose from the optical signal and was reflected at the object and on the basis of a reference signal that was not reflected at the object, wherein, in this alternative apparatus, the angle at which the measurement signal is steered to the object is constant during a period with a monotonic time dependence of the frequency of the optical signal.

According to the invention, the scan rate is increased by virtue of the fact that (as illustrated schematically in FIG. 1) the respective (beam) angle can already be varied by the deflection device during a period for scanning further pixels which is changed monotonically in time with respect to the frequency (the “chirp” within the meaning of a signal which is changed monotonically in time over a relatively long time interval can therefore be decomposed into shorter periods) by virtue of exploiting the fact that, following the reflection of the measurement signal at the object, a frequency-selective division of the measurement signal is realized before merging or forming the difference with the reference signal and also the fact that the above-described assignment “Frequency of the measurement signal Angle of the beam steered on to the object Location on the object (pixel)” is undertaken. Consequently, according to the invention, the scanning device can send different frequency ranges (or the associated partial beams) of a period, which is changed monotonically in time, of the measurement signal to the object under mutually different angles because, although the shorter periods obtained by the aforementioned split are assigned mutually different frequencies (different start frequencies and different mid frequencies), this assignment can then be uniquely re-ascertained by way of the frequency-selective division, for example in an AWG. Expressed differently, according to the invention, the partial signals returning from the object can be distinguished in terms of angle with the aid of the element for frequency-selective spatial division (e.g., the AWG), which is used following the reflection of the measurement signal at the object, since this element always sees the same frequency (corresponding to the same beam angle) at the same location (e.g., channel on the AWG).

Here, the invention takes account of, in particular, the problem that the maximum scan rate realizable when carrying out the scanning process is limited by the light or signal time of flight (TOF) in conventional approaches. Compared to such conventional approaches, the method according to the invention is advantageous in that a substantially faster scanning process can be realized than in a time-of-flight- or TOF-limited method since, as a consequence of the aforementioned inventive assignment “Frequency of the measurement signal Angle of the beam steered on to the object Location on the object (pixel)”, the dwell time of a respective measurement spot on the object to be scanned can be chosen without taking account of the time of flight of the signal and, in particular, can be chosen to be substantially shorter than this time of flight. Expressed differently, on account of the circumstances that the measurement spots or pixels scanned on the object during the scanning process according to the invention are ultimately encoded by different frequencies of the measurement signal, which, in turn, are decoded on the detector side (within the meaning of “demultiplexing”) or assigned to the individual locations on the object (pixel), the time-of-flight- or TOF-limit is lifted, with the consequence that the scan rate ultimately is only restricted by electronics (specifically, by the chirp rate able to be set by the light source and by the frequency resolution obtainable on the detector side of the difference frequencies to be measured in each case).

Objects measured in respect of their distance from the apparatus according to the invention within the scope of the invention can be, in a purely exemplary manner (and without the invention being restricted thereto), robot components such as robot arms or else objects that are relevant in road traffic or in the automotive sector (e.g. other vehicles). In addition to ascertaining the distance, the speed, for example, can also be ascertained (as known per se from US 2016/0299228 A1, for example).

According to one embodiment, the apparatus further comprises an element for frequency-selective spatial division of the measurement signal reflected by the object.

According to one embodiment, this element for frequency-selective spatial division of the measurement signal reflected by the object comprises an AWG (=array waveguide grating). The use of such an AWG is particularly advantageous to the extent that a (wafer-)integrated and hence particularly compact structure is facilitated.

However, the invention is not restricted to the realization of the frequency-selective spatial division by way of an AWG. In further embodiments, use can also be made of a different element bringing about the frequency-selective spatial division or a different dispersive element, for example a prism, a diffraction grating or Bragg grating or a spatial light modulator (e.g., an acoustic or electro-optic modulator).

According to one embodiment, the apparatus comprises a coupler array with a plurality of mutually independently operable coupling elements for respectively separate merging of partial signals, which were generated by the frequency-selective spatial division of the measurement signal reflected by the object, with the reference signal.

According to one embodiment, the apparatus comprises a detector arrangement with a plurality of mutually independently operable detector elements for generating detector signals, wherein these detector signals are each characteristic for the difference frequency between the frequency of the partial signal generated by the frequency-selective spatial division of the measurement signal reflected by the object and the frequency of the reference signal.

According to one embodiment, mutually different detector elements of this detector arrangement are assigned to different angles set by the deflection device.

According to one embodiment, the deflection device comprises a rotatable mirror.

According to one embodiment, the apparatus is designed to capture object distances of more than 30 m, in particular of more than 100 m, further particularly of more than 200 m.

According to one embodiment, the light source is designed to emit the optical signal with a time-varying frequency over a tuning range of more than 100 GHz, in particular of more than 400 GHz, further particularly of more than 1000 GHz.

According to one embodiment, a scan rate of at least 0.6 MHz, in particular of at least 0.8 MHz, further particularly of at least 1 MHz, is obtainable when capturing object distances of up to 100 m with the apparatus.

According to one embodiment, a scan rate of at least 0.3 MHz, in particular of at least 0.4 MHz, further particularly of at least 0.5 MHz, is obtainable when capturing object distances of up to 200 m with the apparatus.

Further configurations of the invention can be gathered from the description and the dependent claims.

The invention will be explained in greater detail below on the basis of an embodiment that is illustrated in the accompanying figures.

### BRIEF DESCRIPTION OF THE DRAWINGS

Further features and advantages of the invention will become apparent from the following description of exemplary embodiments with reference to the drawings, in which:

FIG. 1 shows a schematic illustration for explaining structure and functionality of an apparatus according to the invention;

FIGS. 2 and 3 show schematic illustrations of exemplary obtainable increases in the scan rate in the ascertainment of distance according to the invention; and

FIGS. 4a-4b show schematic illustrations for explaining structure and functionality of a conventional apparatus for ascertaining a distance.

### DETAILED DESCRIPTION OF EMBODIMENTS

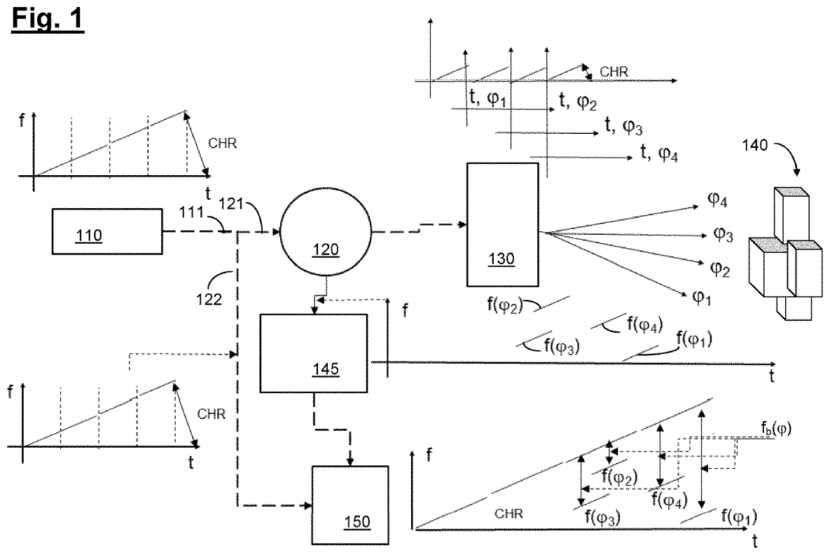

Below, structure and functionality of an embodiment of an apparatus according to the invention are described with reference to the schematic illustration of FIG. 1.

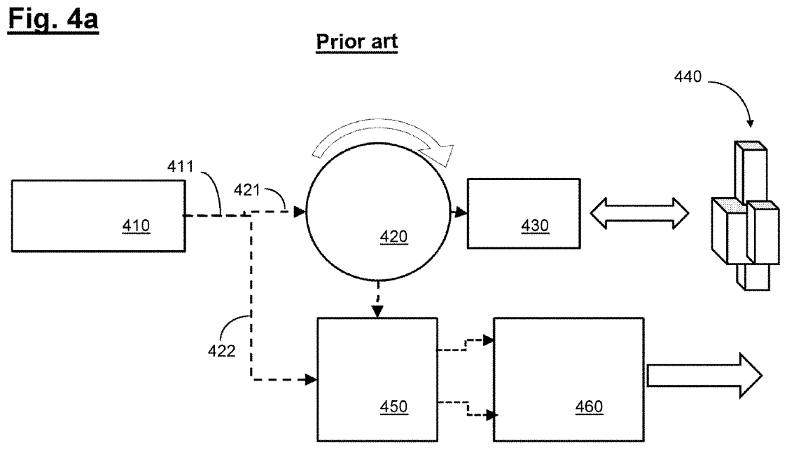

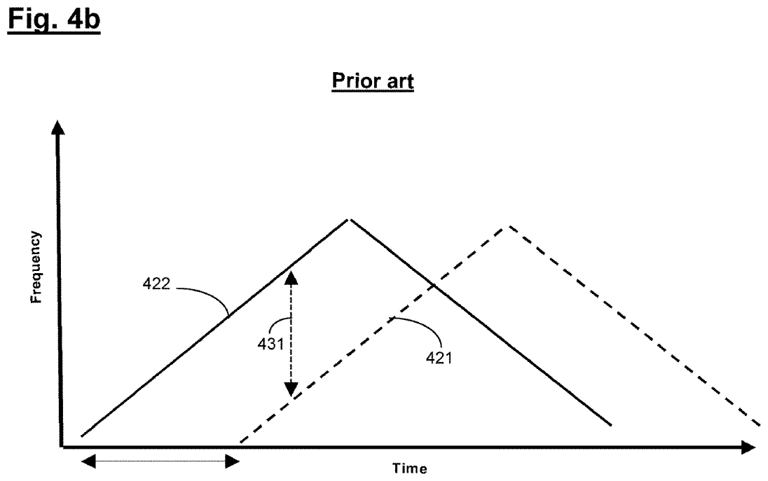

Initially proceeding from the conventional concept already described on the basis of FIGS. 4a-4b, an apparatus according to the invention comprises, as per FIG. 1, a light source 110 for emitting an optical signal 111 with a time-varying frequency (“chirp”). According to the diagram plotted in the upper left part of FIG. 1, this optical signal has a frequency curve with a linear time dependence in this embodiment.

Even though embodiments of the invention can also use periods with opposite time derivatives of the frequency, in a manner analogous to FIG. 4b, only one period of the optical signal 111 with a monotonic time dependence of the frequency is considered below for the purposes of explaining the principle according to the invention.

In a manner likewise analogous to the conventional concept of FIGS. 4a-4b, the signal 111 emitted by the light source 110 is divided as per FIG. 1 by way of, e.g., a partly transmissive mirror, which is not illustrated here. Of these partial signals, a partial signal also referred to as “measurement signal” 121 below is steered via an optical circulator 120 and a scanner 130 to an object 140, which should be measured in respect of its distance from the apparatus, whereas the other of the two partial signals is used as a reference signal 122 for the further evaluation, as described below.

In a manner analogous to FIGS. 4a-4b, the path of the measurement signal 121 passes over a scanner 130, wherein, in contrast to the conventional concept, this scanner 130 comprises, according to the invention, a deflection device for changing the angle at which the measurement signal 121 is steered to the object 140 during respectively one period with a monotonic time dependence of the frequency of the measurement signal 121 or of the underlying signal 111. As a consequence, different deflection angles, which are indicated in FIG. 1 by way of the corresponding propagation directions of the measurement signal 121 and which are denoted by φ₁, φ₂, φ₃, . . . are assigned to mutually different frequencies or frequency ranges, which in turn correspond to different periods in the time curve of the optical signal 111 emitted by the light source 110, when the measurement signal 121 is now steered from the deflection direction of the scanner 130 onto the object 140.

Following the reflection at the object 140, the signal path back extends through the optical circulator 120 to an element 145, designed as an AWG (=“array waveguide grating”) in the embodiment, for the frequency-selective spatial division of the measurement signal reflected by the object 140. On account of the frequency-selective spatial division by the element 145, the different frequencies or frequency ranges are spatially separated from one another. FIG. 1 likewise indicates the frequency curves f(φ₁), f(φ₂), f(φ₃), . . . belonging to the different pixels or angles φ₁, φ₂, φ₃, . . . . Ultimately, the interaction between the deflection device of the scanner 130 (which brings about an assignment between angles and frequencies or frequency ranges) and the element 145 (which brings about an assignment between the frequency or frequency range and location) brings about, overall, an assignment between location, frequency and angle, with the consequence that a coupler array 150 disposed downstream of the element 145 in the beam path can be supplied with the partial signals, which are generated by the frequency-selective spatial division of the measurement signal 121 reflected by the object 140, in such a way that said partial signals correspond to different frequencies or frequency ranges and angles φ₁, φ₂, φ₃, . . . corresponding therewith.

In particular, the coupler array 150 can comprise an array of optical waveguides (e.g., optical fibers), wherein each of these waveguides can be coupled to a detector element (e.g., configured as a photodiode) of a detector arrangement, which is likewise configured as an array. The above-described partial signals generated by the frequency-selective spatial division of the measurement signal 121 are merged in the coupler array 150 with the reference signal 122, as a consequence of which the detector signals generated by the detector arrangement (not illustrated in FIG. 1) are each characteristic—as indicated in the lower right part of FIG. 1—for the difference frequency or the beat frequency f_{b} between, firstly, the frequency of the respective partial signal generated by the frequency-selective spatial division of the reflected measurement signal and, secondly, the frequency of the reference signal. As a result, the associated difference frequency or beat frequency f_{b} and hence, in turn, the associated sought-after distance to the object 140 can be ascertained for each of the angles φ₁, φ₂, φ₃, . . . .

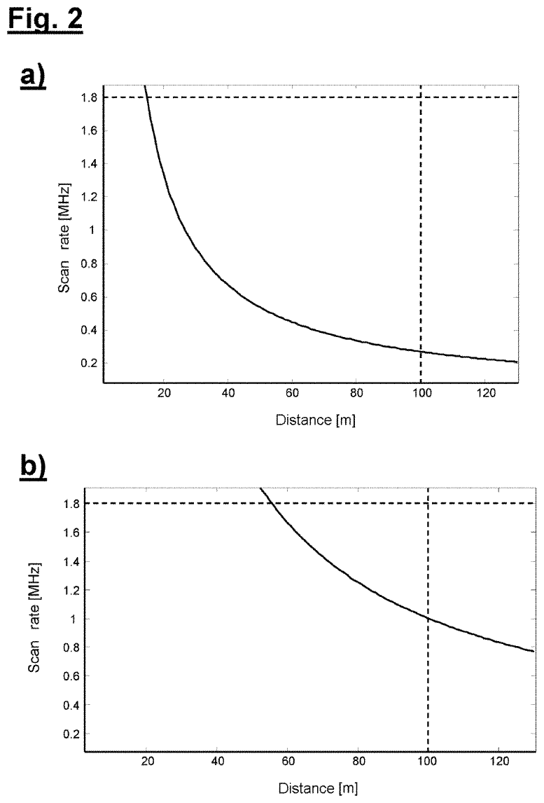

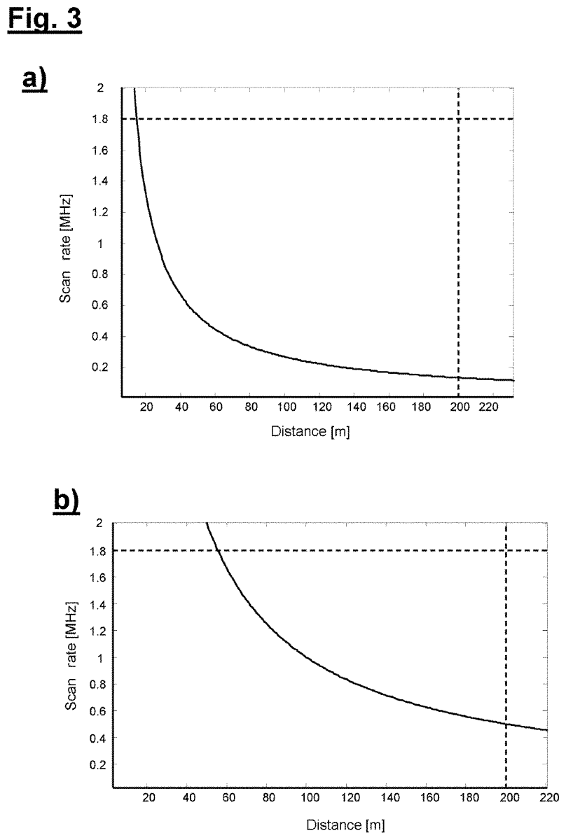

The above-described functional principle of the invention has as a consequence, as explained below on the basis of a comparison calculation on the basis of exemplary values and as illustrated in FIGS. 2 and 3, a substantial increase in the scan rate obtainable for a respectively given object distance:

Here, the invention makes use of the fact that the measurement spots or pixels scanned on the object 140 during the scanning process according to the invention are ultimately encoded by different frequencies of the measurement signal, which, in turn, are decoded on the detector side (within the meaning of “demultiplexing”) or assigned to the individual locations (pixels) on the object 140 such that the timeof-flight- or TOF-limit is lifted. As a consequence, the scan rate ultimately is only restricted by electronics (specifically, by the chirp rate able to be set by the light source and by the frequency resolution obtainable on the detector side of the difference frequencies to be measured in each case), whereas a time overlap between measurement signal and reference signal, required in conventional approaches, can be dispensed with. Expressed differently, what is achieved according to the invention is that the obtainable scan rate approaches the electronic limit (i.e., the limit taking account of the chirp rate able to be set by the light source 110 and the frequency resolution obtainable on the detector side of the difference frequencies to be measured in each case).

The following treatment for comparing scan rates obtainable according to the invention with scan rates obtainable conventionally is based on the following exemplary values according to Table 1:

TABLE 1

| Wavelength | λ₀ | 1.55 | μm |
|---|---|---|---|
| Angular resolution | A | 0.1° | |
| Angular range to be scanned | FoVₓ | 120° | |
| in the x-direction | | | |
| Angular range to be scanned | FoV_{y} | 20° | |
| in the y-direction | | | |
| Maximum capturable | Lₘₐₓ | 200 | m |
| object distance | | | |
| Maximum detectable | f_{b, max} | 2*10⁹ | Hz |
| difference frequency | | | |
| (beat frequency) | | | |
| Resolution of the distance | Res | 0.1 | m |
| measurement in the z-direction | | | |
| Frame rate | FR | 30 | Hz |

| | | |
|---|---|---|
| Tuning range (bandwidth, chirp size) of | CHS | [Hz] |
| the light source | | |
| Chirp duration per pixel | CHD_{1, 2} | [s] |
| Chirp rate | CHR_{1, 2} | [Hz/s] |
| Required chirp size for | CHSres = | [Hz] |
| obtaining the resolution Res | c/(2*Res) | |
| Time of flight | TOF = 2*Lₘₐₓ/c | [s] |
| Scan rate | SR_{1, 2} | [Hz] |

Chirp rates able to be set by the light source 110 can typically range between (10¹³-10¹⁶) Hz/s, in particular (10¹⁴-10¹⁵) Hz/s, as a matter of principle. In the case of a conventional, time-of-flight- or TOF-limited scanning method, the minimum achievable measurement time per pixel (chirp duration CHD) and hence the obtainable scan rate SR are restricted by the required temporal overlap between the measurement signal and reference signal. This temporal overlap arises from the product of the time of flight TOF (which, in the case of an exemplary object distance of L=150 m and the speed of light c=3*10⁸ m/s, emerges as TOF=2*150 m/(3*10⁸ m/s)=1 μs) and an electronics-dependent factor k, for which a typical value of k=5.6 is used in exemplary fashion here.

In both scenarios, the scan rate SR_{1,2} respectively emerges as the reciprocal of the chirp duration CHD₁ and CHD₂. Said chirp duration CHD_{1,2} now adopts different values depending on whether the first scenario of the conventionally given time-of-flight-limit of the chirp duration is present or whether this chirp duration is only limited by electronics according to the invention in the second scenario:

In the conventionally given first scenario with the TOF-limit, the following applies to the chirp duration per pixel with the aforementioned, electronics-dependent factor k: CHD₁=2*k*(L/c). Using the aforementioned values, a value of CHD₁=2*k*(L/c)=2*5.6*200 m/(3*10⁸ m/s)≅7.46610⁻⁶ s arises for the chirp duration per pixel, from which a value of SR₁=1/CHD₁≅0.134 MHz follows for the scan rate in the first scenario.

By contrast, in the second, inventive scenario where the scan rate is only limited by the electronics CHR₂=f_{b,max}*c/(2*L) applies, from which the following follows for the chirp duration per pixel:

CHD₂=CHSres/CHR₂=c*2*L/(2*Res*f_{b,max}*c)=L/(Res*f_{b,max}).

Using the aforementioned values, a value of CHD₂=L/(Res*f_{b,max})=200 m/(0.1 m*10⁹ Hz)=2*10⁻⁶ s arises for the chirp duration per pixel, from which a value of SR₂=1/CHD₂≅5*10⁵ Hz=0.5 MHz follows for the scan rate in the second scenario according to the invention. It should be observed that in the case of an increase in the maximum detectable difference frequency (beat frequency) f_{b,max} beyond the value of 2*10⁹ Hz specified in the calculation example, which may be possible in future applications, the chirp duration can be reduced even further according to the invention and hence the scan rate can be increased even more.

The tuning range CHS to be traversed by the light source 110 for complete coverage of an angular range to be scanned in the x-direction of FoVₓ=120° with an angular resolution of A=0.1° emerges as follows: For this angular range to be scanned, the number of pixels to be scanned equals the value of FoVₓ/A. The required bandwidth CHS, corresponding to the tuning range, for covering the aforementioned angular range emerges as CHS=2*CHSres*FoVₓ/A (with the factor of 2 being introduced here in order to ensure that the total chirp size CHS is sufficient for all potential object distances or pixels up to the maximum distance to be captured). Using the values assumed in the example, the following arises for the tuning range: CHS=2*c*FoVₓ/(2*Res*A)=(2*3*10⁸ m/s*120°)/(2*0.1m*0.1°)=3.6*10¹² Hz=3.6 THz. In relation to the wavelength, this tuning range emerges as Δλ=λ₀²*(CHS/c)=(1.55*10⁻⁶ m)²*3.6*10¹² Hz/(3*10⁸ m/s)≅28.8 nm.

On the basis of the aforementioned calculation and proceeding from the aforementioned values, the diagrams of FIG. 2 (with the capture of object distances of up to 100 m) and FIG. 3 (with the capture of object distances of up to 200 m) each plot the reduction in the scan rate (i.e., the scan speed with which the object 140 can be scanned) with increasing object distance, with diagram a of FIG. 2 and diagram a of FIG. 3 each showing the curves obtainable for the conventional concept of FIGS. 4a-4b and with diagram b of FIG. 2 and diagram b of FIG. 3 each showing the improvement obtained according to the invention. While a scan rate of only approximately 268 kHz is achievable according to diagram a of FIG. 2 for capturing object distances of up to 100 m, this scan rate can be increased to a value of almost 1 MHz according to diagram b of FIG. 2. In turn, this means that approximately seven appropriate apparatuses for measuring the distance are required in the conventional concept as per diagram a of FIG. 2 for the purposes of fulfilling a scan rate of, e.g., 1.8 MHz, while the use of only two apparatuses is sufficient in the concept according to the invention as per diagram b of FIG. 2. As is evident from diagram a of FIG. 3 and diagram b of FIG. 3, the effect obtainable according to the invention is even more pronounced for greater object distances to be captured. While a scan rate of only approximately 134 kHz is achievable according to diagram a of FIG. 3 for capturing object distances of up to 200 m, this scan rate can be increased to a value of approximately 0.5 MHz according to diagram b of FIG. 3. In this case, approximately thirteen appropriate apparatuses for measuring the distance are required in the conventional concept as per diagram a of FIG. 3 for the purposes of fulfilling a scan rate of, e.g., 1.8 MHz, while the use of only four apparatuses is sufficient in the concept according to the invention as per diagram b of FIG. 3. Consequently, a substantial increase in the scan rate can be obtained according to the invention, particularly in the case of objects which are comparatively far away (e.g., several 100 m) and should be measured in terms of their distance. As a consequence, the number of (LIDAR) apparatuses required to obtain a given scan rate can also be significantly reduced.

Even though the invention has been described on the basis of specific embodiments, numerous variations and alternative embodiments will be apparent to the person skilled in the art, for example through combination and/or exchange of features of individual embodiments. Accordingly, it goes without saying for the person skilled in the art that such variations and alternative embodiments are concomitantly encompassed by the present invention, and the scope of the invention is restricted only within the meaning of the appended patent claims and the equivalents thereof.

1. An apparatus for ascertainment of a distance to an object, wherein the apparatus comprises
a light source configured to emit an optical signal having a time-varying frequency,
an evaluation device configured to ascertain a distance to the object based on
a measurement signal that originated from the optical signal and was reflected at the object and
a reference signal that was not reflected at the object, and
a deflection device configured to change an angle, at which the measurement signal is steered to the object, during a period of the optical signal in which the frequency of the optical signal has a monotonic time dependence.

2. The apparatus of claim 1, comprising an element configured to produce a frequency-selective spatial division of the measurement signal reflected at the object.

3. The apparatus of claim 2, wherein the element comprises an array waveguide grating (AWS).

4. The apparatus of claim 2, wherein the element comprises a prism, a diffraction grating or a spatial light modulator.

5. The apparatus of claim 4, wherein the spatial light modulator is an acoustic modulator or an electro-optic modulator.

6. The apparatus of claim 2, comprising a coupler array that has a plurality of mutually independently operable coupling elements for separate merging of partial signals, which were generated by the frequency-selective spatial division of the measurement signal reflected at the object, with the reference signal.

7. The apparatus of claim 2, comprising a detector arrangement that has a plurality of mutually independently operable detector elements configured to generate detector signals, wherein the detector signals are each characteristic for a difference frequency between the frequency of partial signals, which were generated by the frequency-selective spatial division of the measurement signal reflected at the object, and the frequency of the reference signal.

8. The apparatus of claim 7, wherein mutually different detector elements of the detector arrangement are assigned to different angles set by the deflection device.

9. The apparatus of claim 1, wherein the deflection device comprises a rotatable mirror.

10. The apparatus of claim 1, wherein the apparatus is configured to ascertain object distances of more than 30 m.

11. The apparatus of claim 1, wherein the light source is configured to emit the optical signal with a time-varying frequency over a tuning range of more than 100 GHz.

12. The apparatus of claim 1, wherein a scan rate of at least 0.6 MHz is obtainable when ascertaining object distances of up to 100 m.

13. The apparatus of claim 1, wherein a scan rate of at least 0.3 MHz is obtainable when ascertaining object distances of up to 200 m.

14. An apparatus for ascertainment of a distance to an object, wherein the apparatus comprises
a light source configured to emit an optical signal having a time-varying frequency,
an evaluation device configured to ascertain a distance to the object based on
a measurement signal that originated from the optical signal and was reflected at the object and
a reference signal that was not reflected at the object,
a deflection device configured to change an angle, at which the measurement signal is steered to the object, during a period of the optical signal in which the frequency of the optical signal has a monotonic time dependence,
an element configured to produce a frequency-selective spatial division of the measurement signal reflected at the object, and
a coupler array having a plurality of mutually independently operable coupling elements, wherein the coupling elements are configured to merge partial signals, which were generated by the frequency-selective spatial division of the measurement signal reflected at the object, with the reference signal.
